(19) United States
(12) Patent Application Publication
(10) Pub. No.: US 2026/0027697 A1
(43) Pub. Date: Jan. 29, 2026

(54) MULTITOOLS AND BIT RETAINERS THEREFOR

(71) Applicant: HACKSMITH ENTERTAINMENT LTD., Cambridge (CA)

(72) Inventors: Jamie Alexander HOBSON, Cambridge (CA); Benjamin MCDONNELL, Cambridge (CA); Ian Douglas HILLIER, Cambridge (CA)

(21) Appl. No.: 19/279,131

(22) Filed: Jul. 24, 2025

Related U.S. Application Data
(60) Provisional application No. 63/675,425, filed on Jul. 25, 2024.
(60) Provisional application No. 63/760,754, filed on Feb. 20, 2025.

(51) Int. Cl. B25G 1/08; B26B 11/00; H01F 7/02

(52) U.S. Cl. CPC B25G 1/085; B26B 11/00; H01F 7/0252

(57) ABSTRACT

A multitool includes (a) a handle extending along a tool axis; (b) at least one tool movably mounted to the handle for movement between a deployed position and a stowed position; and (c) a bit retainer integrated into the handle for storing a plurality of tool bits. The bit retainer includes one or more bit storage slots. Each bit storage slot retains a respective pair of tool bits at axially opposite ends of the slot. Each tool bit is selectively slidable along a respective slot from a storage position adjacent a respective end of the slot in which the bit is securely retained in the slot, to an extraction position toward a center of the slot from which the bit is removable from the slot for insertion into a bit socket of the multitool for use.

### CROSS-REFERENCE TO RELATED APPLICATIONS

This application claims the benefit of U.S. Provisional Patent Application No. 63/675,425 filed Jul. 25, 2024 and U.S. Provisional Patent Application No. 63/760,754 filed Feb. 20, 2025, each of which is hereby incorporated herein by reference in its entirety.

### FIELD

The teachings disclosed herein relate generally to tools, and more specifically, to handheld tools with tool bit retainers.

### INTRODUCTION

Popular multitool designs can often include a small pair of fixed-joint pliers, with other accessory tools stored in the multi-tool handle. These accessory tools can include, for example, a knife, a file, a flat-head screwdriver, a phillips-head screwdriver, a can-opener, scissors, and/or various other tools. When plier and screwdriver functionality is combined, this can result in an undersized screwdriver tool that may be difficult to use due to its construction and action of the tool's handle when the screwdriver is deployed for use. Furthermore, multitools are often purposely configured to be compact in design and light-weight in structure, such that they can easily be stored in a belt holster. Typically, all of the accessory tools in such designs fold out from within a container within the tool handle. These fold-out tools can be relatively small, simplistic, and/or blunt in design, compared with their equivalent single-purpose counterparts.

### SUMMARY

The following summary is intended to introduce the reader to various aspects of the applicant's teaching, but not to define any invention.

A multitool includes: (a) a handle extending along a tool axis; (b) at least one tool movably mounted to the handle, each tool movable relative to the handle between a deployed position in which the tool projects from the handle for use, and a stowed position in which the tool is nested in the handle; and (c) a bit retainer integrated into the handle for storing a plurality of tool bits. The bit retainer includes one or more bit storage slots, each slot for storing a respective pair of tool bits at axially opposite ends of the slot. Each tool bit is selectively slidable along a respective slot from a storage position adjacent a respective end of the slot in which the bit is securely retained in the slot, to an extraction position toward a center of the slot from which the bit is removable from the slot for insertion into a bit socket of the multitool for use.

In some examples, the bit retainer comprises a plurality of bit storage slots spaced laterally apart and extending parallel to each other for retaining respective pairs of tool bits.

In some examples, the slot comprises a slot channel extending between the axially opposite ends of the slot, the slot channel having a cross-sectional profile corresponding generally in size and shape to that of the bits for receiving the bits therein in close sliding fit for sliding along the slot channel between the storage and extraction positions.

In some examples, the slot comprises a slot opening extending along the channel over the storage and extraction positions to permit engagement of the tool bits by a user to facilitate the sliding between the storage and extraction positions and removal from the extraction position.

In some examples, the slot opening is narrower than the slot channel and the tool bits along at least a portion of each storage position for retaining the tool bits within the slot channel in the storage positions, and the slot opening is wider than the tool bits along the extraction position to permit removal of the bits from the slot channel when in the extraction position.

In some examples, the slot channel has a channel length between the axially opposite ends of the slot and a generally constant internal width along the channel length, the internal width corresponding to a bit width of the tools bits to facilitate insertion and sliding of the tool bits along the channel.

In some examples, the slot opening has a pair of storage zones extending along respective storage positions and an extraction zone extending along the extraction position, each storage zone of the slot opening having a storage zone width that is less than a bit width of the tool bits for retaining the bits when in the storage position, and the extraction zone of the slot opening has an extraction zone length greater than a bit length of the tool bits and an extraction zone width greater than the bit width to permit insertion and removal of the bits through the extraction zone of the slot opening.

In some examples, the extraction zone length is at least twice the tool bit length to permit both tool bits to be in respective extraction positions along the extraction zone of the same slot simultaneously.

In some examples, each end of the slot has a retention mechanism for axially securing the bit in the storage position.

In some examples, each retention mechanism comprises a respective magnet to attract the bit to the storage position.

In some examples, the bit retainer includes a spring-loaded ejector having at least one spring in each slot for urging ejection of each bit from the slot when in the extraction position.

In some examples, the bit retainer has a respective retention mechanism along each storage position of the slot for axially securing a respective bit in the storage position. In some examples, the retention mechanism includes an upper protrusion surface projecting downwardly from a ceiling of the slot to urge the bit downward against spring force of the spring as the bit is slid along the slot from the extraction position toward the storage position, and a lower ramp surface spaced inward from the upper protrusion surface toward the end of the slot for elevating the bit after clearing the upper protrusion surface to facilitate retention of the bit in the storage position.

In some examples, the at least one tool projects lengthwise along the tool axis from a head end of the handle when in the deployed position, and is nested in the handle along the tool axis when in the stowed position.

In some examples, the at least one tool is pivotable between the stowed position and the deployed position.

In some examples, the at least one tool comprises a knife blade.

In some examples, the bit socket is at a butt end of the handle axially opposite the head end.

In some examples, the bit socket is generally coaxial with the tool axis.

In some examples, the handle includes a plurality of bit sockets into which each bit is insertable, the plurality of bit sockets including a first bit socket oriented coaxial with the tool axis and a second bit socket oriented perpendicular to the tool axis.

In some examples, the handle has a length along the tool axis and a generally constant cross-sectional profile along the length, the cross-sectional profile defined by a width across the tool axis and a thickness perpendicular to the width, the thickness being at least three-fifths of the width.

In some examples, the handle comprises a pair of parallel plates configured to capture the at least one tool therebetween when the tool is in the stowed position.

In some examples, the one or more storage slots are formed integrally in at least one of the plates.

According to some aspects, a tool includes a bit retainer integrated into a portion of the tool for storing a plurality of tool bits. The bit retainer includes one or more slots, each slot retaining a respective pair of tool bits at axially opposite ends of the slot. Each tool bit is selectively slidable along a respective slot from a storage position adjacent a respective end of the slot in which the bit is securely retained in the slot, to an extraction position toward a center of the slot from which the bit is removable from the slot for insertion into a bit socket of the tool for use.

According to some aspects, a bit retainer for a tool includes a retainer body having one or more slots, each slot retaining a respective pairs of tool bits at axially opposite ends of the slot. Each tool bit is selectively slidable along a respective slot from a storage position adjacent a respective end of the slot in which the bit is securely retained in the slot, to an extraction position toward a center of the slot from which the bit is removable from the slot for insertion into a bit socket of the tool for use.

### DRAWINGS

For a better understanding of the described examples and to show more clearly how they may be carried into effect, reference will now be made, by way of example, to the accompanying drawings in which:

FIG. 1 is a perspective view of an example multitool, showing a tool of the multitool in a stowed position;

FIG. 2 is a perspective view of the multitool of FIG. 1, but showing the tool in a deployed position;

FIG. 3 is an exploded perspective view of the multitool of FIG. 2;

FIG. 4 is a side view of the multitool of FIG. 2;

FIG. 5 is an end view of the multitool of FIG. 2;

FIG. 6 is a cross-sectional view of the multitool of FIG. 2, taken along line 6-6 of FIG. 4 corresponding to a tool bit extraction zone of the multitool;

FIG. 7 is another cross-sectional view of the multitool of FIG. 2, taken along line 7-7 of FIG. 4 corresponding to a tool bit storage zone of the multitool;

FIG. 8 is a perspective view of a bit retainer portion of the multitool of FIG. 1;

FIG. 9 is an outer side view of the bit retainer portion of FIG. 8;

FIG. 10 is a cross-sectional view of the bit retainer portion of FIG. 8, taken along line 10-10 of FIG. 9 corresponding to another tool bit storage zone of the multitool;

FIG. 11 is a cross-sectional view of the bit retainer portion of FIG. 8, taken along line 11-11 of FIG. 9 corresponding to the tool bit extraction zone;

FIG. 12 is an underside view of the bit retainer portion of FIG. 8;

FIG. 13 is an enlarged view of a portion of FIG. 12, but with one magnet removed;

FIG. 14 is a close-up perspective view of an underside section of the bit retainer portion of FIG. 8;

FIG. 15 is a first side view of the multitool of FIG. 1;

FIG. 16 is a first edge view of the multitool of FIG. 1;

FIG. 17 is a second side view of the multitool of FIG. 1;

FIG. 18 is a second edge view of the multitool of FIG. 1;

FIG. 19 is a perspective view of another example multitool;

FIG. 20 is an exploded perspective view of the multitool of FIG. 19;

FIG. 21 is a side view of the multitool of FIG. 19;

FIG. 22 is a cross-sectional view of the multitool of FIG. 19, taken along line 22-22 of FIG. 21 corresponding to a tool bit extraction zone of the multitool; and

FIG. 23 is a cross-sectional view of the multitool of FIG. 19, taken along line 23-23 of FIG. 21 corresponding to a tool bit storage zone of the multitool;

FIG. 24 is a side view of another example multitool, showing a tool of the multitool in a stowed position, three bits in respective storage positions in a bit retainer of the multitool, and a fourth bit in an extraction position;

FIG. 25 is another side view of the multitool of FIG. 24, showing the fourth bit removed from the bit retainer of the multitool;

FIG. 26 is a close-up view of an example pen bit in a storage position in a bit retainer of another example multitool;

FIG. 27 is a perspective view of another example multitool;

FIG. 28 is a side view of the multitool of FIG. 27;

FIG. 29 is a cross-sectional view of a portion of the multitool of FIG. 27, taken along line 29-29 in FIG. 28;

FIG. 30 is a perspective view of a bit ejector mechanism of the multitool of FIG. 27;

FIG. 31A-31D are side cross-sectional views showing an example bit at various stages during loaded into a storage position of the multitool of FIG. 27, and with the ejector mechanism omitted;

FIG. 32 is a partially exploded perspective view from a first side of portions of the multitool of FIG. 27;

FIG. 33 is a partially exploded perspective view from a second side of portions of the multitool of FIG. 27; and

FIG. 34 is a side view of a blade portion of the multitool of FIG. 27.

### DESCRIPTION OF VARIOUS EXAMPLES

Various apparatuses, systems, or processes will be described below to provide an example of each claimed invention. No example described below limits any claimed invention and any claimed invention may cover processes, systems, or apparatuses that differ from those described below. The claimed inventions are not limited to apparatuses, systems, or processes having all of the features of any one apparatus, system, or process described below or to features common to multiple or all of the apparatuses, systems, or processes described below. It is possible that an apparatus, system, or process described below is not an example of any claimed invention. Any invention disclosed in an apparatus, system, or process described below that is not claimed in this document may be the subject matter of another protective instrument, for example, a continuing patent application, and the applicants, inventors, or owners do not intend to abandon, disclaim, or dedicate to the public any such invention by its disclosure in this document.

The present disclosure relates to handheld multitools that can include a plurality of deployable tools. In some examples, the multitool can be in the form of a folding pocket knife multitool, which can include a deployable knife blade and tool bits (e.g. screwdriver bits) stored in a body of the multitool. The body of the multitool can serve as a handle for the multitool—for example, such as a knife handle when the knife is deployed, and as a driver handle when driver tool bits are deployed.

The multitool of the present disclosure can include a bit retainer for storing the tool bits, and a bit socket for use with the bits to enable the multitool to serve as a screwdriver and/or writing tool. For example, the bits can include one or more screwdriver bits for driving fasteners and one or more writing bits (e.g. pen or pencil tip) to serve as a writing implement. When not in use, the bits can be stored within the body of the tool, enabling the user to use the tool as a pocket knife without interference from the tool bits of the multitool. The bits can be movably stored within the body of the multitool to enable them to be secured within the body (e.g. using detents or magnets) and extracted by hand (and without requiring external tools) for loading a selected bit into an integrated bit socket of the multitool for use (e.g. as a screwdriver or writing implement). The tool bits can be housed in a bit retainer integrated into the handle of the multitool. In some examples, the bit retainer can be in the form of a slide housing for storing a plurality of sliding bits, such as bits provided with the multitool, or different bits of the user's choosing. The multitool can remain usable whether the bits are stored or deployed for use.

The multitool of the present disclosure can include a plurality of tools/accessories/features, including, for example:
Pocket knife;
Screwdriver bits (e.g. three bits, such as Phillips, Flat, Torx, etc.);
Pen bit;
Material file (e.g. along a back edge of the knife blade, which can also serve to enhance grip);
Tweezers;
Pry bar (e.g. which can serve as a bottle opener, and/or an integrated nail puller with a corresponding nail puller opening/slot);
Window/glass breaker;
Ruler (e.g. along a back edge of the multitool body and optionally also the spine of the blade to extend ruler length, usable in both deployed and stowed positions of the knife blade, and in inch and/or metric);
Belt clip (e.g. to enhance usability and stowability of the multitool, and which can be switchable between two or more positions for ease of use or improved safety, and which can further include an integrated tie-off point for rope);
Light source (e.g. a self-luminous/radioluminescent light source, such as a tritium or other glow-in-the-dark vial to facilitate visibility in the dark, which can be held in a designated vial holder/spot in the handle);
Wire stripper (e.g. a section along an edge of the handle for stripping up to 12 AWG wire);
Fire starting flint (e.g. flint strip/block of fire steel);
Protractor feature integrated with the blade and handle (e.g. to measure 15 and/or 30 degree increments of the blade angle relative to the handle, from 0 to 180 degrees when moving the blade between the stowed and deployed positions); and/or
Bubble level.

In some examples, the multitool of the present disclosure can present a variety of functions while maintaining ergonomics, functionality/usability, and/or aesthetic details related to the materials being used and overall shape/design of the handle/body of the tool. In some examples, the multitool of the present disclosure is configured to serve primarily as a knife and secondarily as a screwdriver, and can provide additional (tertiary) tools/accessories/functionality. In its standard closed/stowed configuration (with the knife and bits stowed), the multitool can be free of any exposed tool edges (e.g. either of the knife or bits) which could otherwise present danger, inconvenience, or discomfort to the user.

Aspects of the multitool design of the present teachings can also help provide for a balanced screwdriver assembly to facilitate ease of use and ergonomics, as well as providing a pocket knife, and/or a variety of other functions as disclosed herein. Some multitool designs fail to suitably integrate driver bit and storage functionality without compromising usability of the bit or other tools/accessories of the multitool (e.g. a relatively large and capable knife also stowable within the body of the tool). In some examples, the multitool of the present disclosure can provide a handle that extends along a tool axis and can be relatively rotationally symmetric about the tool axis (e.g. being generally square/circular in cross-section, having an order of rotational symmetry of 2, 3, 4, 5 or more about the tool axis, and/or having a generally rectangular cross-sectional profile with a ratio of width to thickness having a relatively low disparity, e.g. of less than 2:1, or less than 5:3). This can enable the tool to be used as a driver or writing implement with ergonomic rotational capabilities in the hand, unlike some other tool designs which have nonsymmetric/offset body or driver designs (e.g. having rectangular/oblong cross-sectional profiles that are not constant along the length and/or with high disparity ratios of width to thickness (e.g. exceeding a 2:1 ratio), making the tool feel rotationally unbalanced and its action as a bit driver inferior to generally symmetric single-purpose screw driver designs). The generally rotationally symmetric design of some of the present multitool body designs and relative positioning of the bit socket can provide concentricity of the bit driver elements when in use, and enhance the ability of the user to apply consistent torques and more precise or finer repeated turning motions for both unscrewing and screwing of various fasteners or other items. The concentricity features can further facilitate ergonomic use of the multitool as a writing implement with a writing bit (e.g. pen or pencil tip) in the bit holder, which can be more uncomfortable in other devices without similar features.

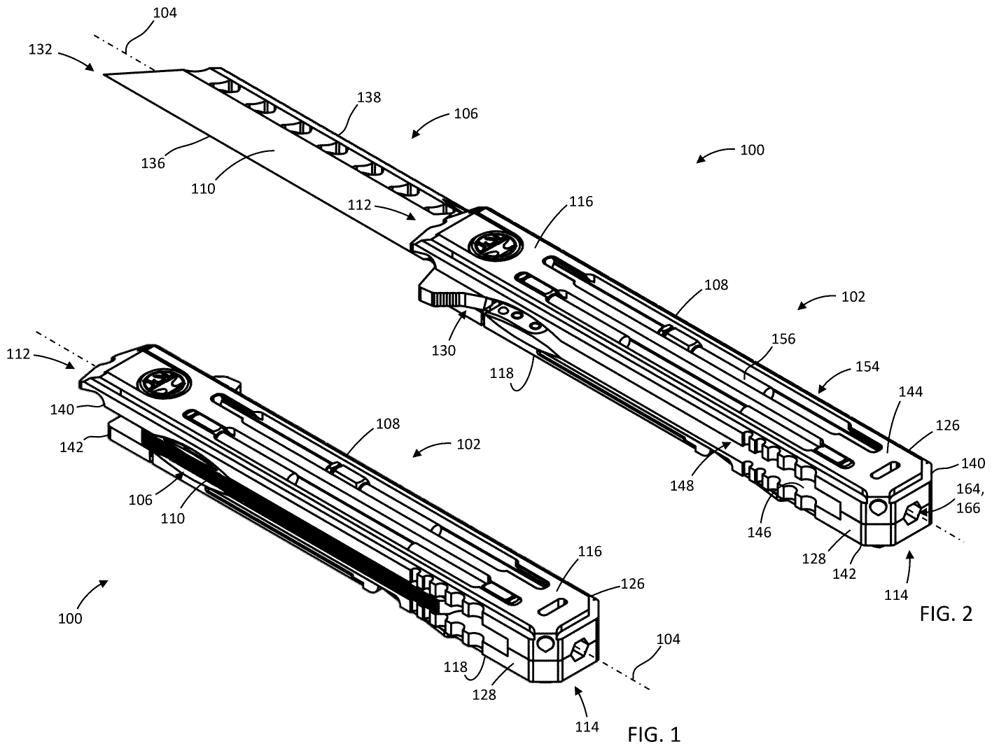

Referring to FIG. 1, an example multitool 100 is shown. The multitool 100 includes a body 102 extending along a tool axis 104 and at least one tool 106 movably mounted to the body 102. Referring to FIG. 2, the tool 106 is movable relative to the body 102 between a deployed position (shown in FIG. 2) in which the tool 106 projects from the body 102 for use, and a stowed position (shown in FIG. 1) in which the tool 106 is nested in the body 102.

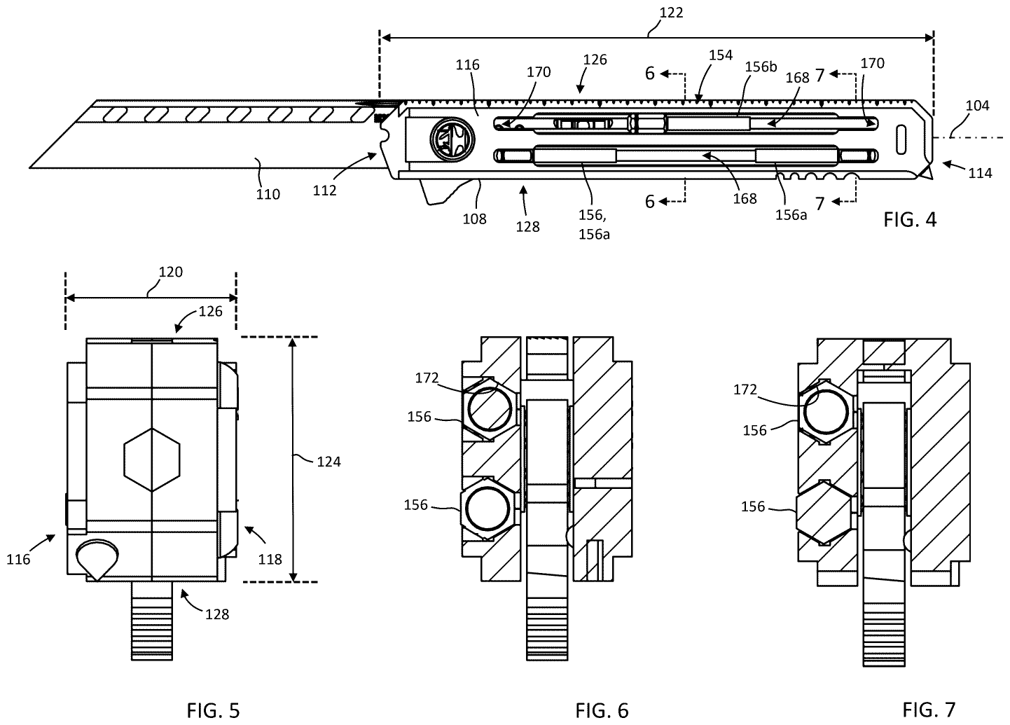

In the example illustrated, the body 102 comprises a handle 108 for grasping by a user and the tool 106 comprises a knife blade 110. The handle 108 extends along the tool axis 104 between a first (head) end 112 and a second (butt) end 114 axially opposite the head end 112. The handle 108 has a first face 116 and a second face 118 opposite the first face 116 and spaced apart from the first face 116 by a handle thickness 120 (FIG. 5). In the example illustrated, the first and second faces 116, 118 are generally planar and parallel to each other. The first and second faces 116, 118 extend axially along the tool axis 104 between the head and butt ends 112, 114 of the handle 108 over a handle length 122 (FIG. 4). The first and second faces 116, 118 extend laterally across the tool axis 104 over a handle width 124 (FIG. 5) between a first (back) edge 126 of the handle 108 and a second (belly) edge 128 of the handle 108 laterally opposite the back edge 126. In the example illustrated, the first and second edges 126, 128 are generally planar and parallel to each other.

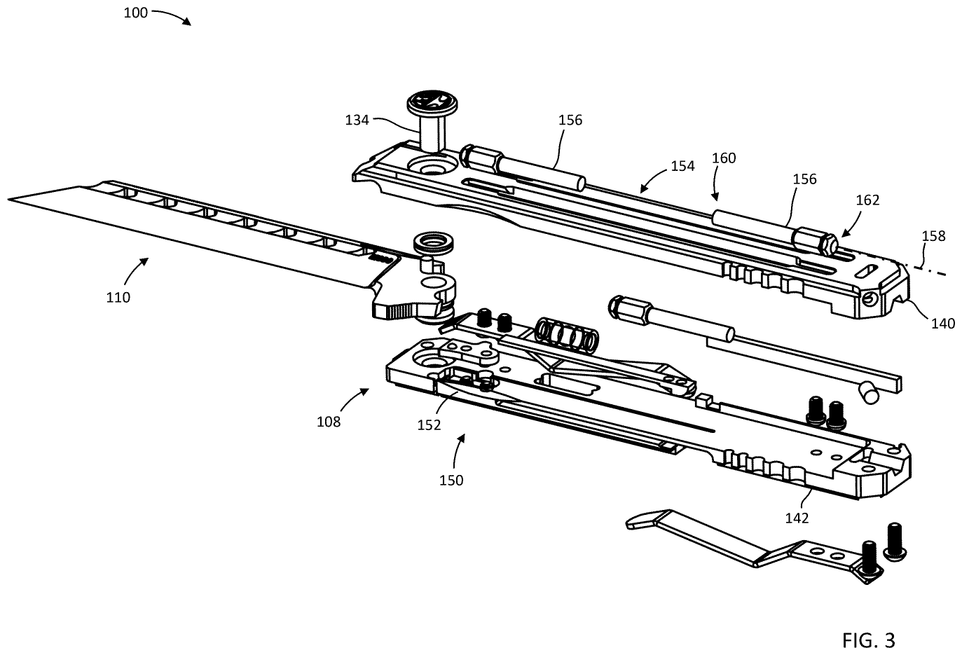

Referring to FIG. 2, when in the deployed position, the blade 110 projects from the head end 112 of the handle 108 lengthwise along the tool axis 104 from a tang portion 130 coupled to the handle 108 at the head end 112 and a tip 132 axially opposite and ahead of the tang portion 130. The tang portion 130 is pivotably coupled to the handle 108 for pivoting about a locking pivot pin 134 (FIG. 3) of the handle 108 between the deployed and stowed positions. The blade 110 has a cutting edge 136 extending along the length of the blade 110 from the tip 132 to the tang portion 130, and a spine 138 opposite the cutting edge 136. When the blade 110 is in the deployed position, the cutting edge 136 projects forward from the belly edge 128 of the handle 108 and the spine 138 of the blade 110 projects forward from the back edge 126 of the handle 108. When in the stowed position (FIG. 1), the blade 110 is nested within the handle 108 generally parallel with the tool axis, with the cutting edge 136 enclosed within the handle 108 toward the back edge 126, and the spine 138 of the blade 110 extending along the belly edge 128 of the handle 108 generally flush therewith.

In the example illustrated, the handle 108 comprises a pair of frame halves on opposite sides of the handle 108. In the example illustrated, the pair of frame halves comprise first and second plates 140, 142 arranged generally coplanar to each other on opposite sides of the handle 108. The first and second plates 140, 142 are formed of metal (e.g. titanium) in the example illustrated. Each of the first and second plates 140, 142 has an exterior surface 144 defining a respective first and second face 116, 118 of the handle 108, and an interior surface 146 opposite the exterior surface 144. Portions of the interior surfaces 146 of the first and second plates 140, 142 are spaced apart from each other to define a blade cavity 148 within the handle 108. The blade cavity 148 is open to the head end 112 and belly edge 128 of the handle 108 for receiving the blade 110 therein when in the stowed position for nesting within the handle 108. The respective edges and ends of the first and second plates 140, 142 are generally aligned to together define the head end 112, butt end 114, back edge 126, and belly edge 128 of the handle 108.

Referring to FIG. 3, in the example illustrated, the handle 108 comprises a lock 150 for selectively locking and unlocking the blade 110 into and out of the deployed position. In the example illustrated, the lock 150 is in the form of a frame lock and includes a deflectable locking bar 152 formed in the second plate 142 (through a frame lock cutout in the second plate 142). When the blade 110 is in the stowed position, a locking bar stop surface fixed relative to the locking bar 152 is biased inwardly toward the blade cavity 148 against the blade 110. When the blade 110 is moved into the deployed position, the blade 110 moves clear of the locking bar stop surface to accommodate movement of the locking bar stop surface inwardly toward the blade cavity 148 into the return path of the blade 110 to engage and block pivoting of the blade 110 back toward the stowed position for locking the blade 110 in the deployed position. The locking bar 152 is movable clear of and out of engagement with the blade 110 through deflection by a user outwardly away from the blade cavity 148 to permit movement of the blade 110 back to the stowed position.

In the example illustrated, the multitool 100 includes a bit retainer 154 integrated into the handle 108 for storing a plurality of tool bits 156 and permitting a user to extract any one of the bits 156 from the bit retainer 154 for use. Each bit 156 extends along a bit axis 158 between a bit head 160 (working end) and a shank 162 axially opposite the bit head 160. Referring to FIG. 2, the multitool 100 further includes a bit holder 164 for selectively receiving and securely holding the shank of any one of the bits 156 for use thereof. In the example illustrated, the bit holder 164 comprises a bit socket 166 formed integrally in the butt end 114 of the handle 108 and aligned generally coaxial with the tool axis 104. In the example illustrated, the bit socket 166 comprises a split socket, with a first socket half of the bit socket 166 formed in the first plate 140 and a second socket half of the bit socket 166 formed in the second plate 142. In the example illustrated, the bit socket 166 comprises a hex bit socket and the tool bits 156 comprise hex-shank bits. One or more of the bits 156 can comprise, for example, screwdriver bits, and one or more of the bits 156 can comprise, for example, a writing implement (e.g. a pen bit 3156 as shown in FIG. 25, having a pen tip and a hex shank for insertion into a bit holder like the bit socket 166). The hex shank can comprise, for example, a 4 mm or ¼-inch hex shank. Referring to FIGS. 4 to 7, in the example illustrated, the handle 108 has a cross-sectional profile that is generally constant along the handle length 122, and the handle thickness 120 can be at least one-half of the handle width 124, which can help provide for improved ergonomic rotational capabilities in the hand of the user relative to some other multitool driver designs with less rotationally symmetric designs. In the example illustrated, the handle thickness 120 is at least three-fifths of the handle width 124.

Referring to FIG. 4, in the example illustrated, the bit retainer 154 comprises one or more bit storage slots 168 for storing the tool bits 156. In the example illustrated, each slot 168 extends along the tool axis 104 between axially opposite ends 170 of the slot 168. Each slot 168 is configured to retain a respective pair of tool bits 156 at respective ends 170 of the slot 168. When received in the slot 168, the bit axis 158 (FIG. 3) of each tool bit 156 is oriented parallel with the slot 168 (and tool axis 104). Each tool bit 156 is selectively slidable along a respective slot 168 from a respective storage position (shown for tool bits 156a) adjacent a respective end 170 of the slot 168 to an extraction position (shown for tool bit 156b) spaced apart from the storage position toward a center of the slot 168. When in respective storage positions, the bits 156 are securely retained in the slot 168 to inhibit removal of the bits 156 in the storage position from the slot 168. When in respective extraction positions, the bits 156 are removable from the slot 168 (e.g. for insertion into the bit socket 166 for use). In the example illustrated, the bit retainer 154 comprises a pair of the bit storage slots 168 spaced laterally apart and extending parallel to each other for storing respective pairs of tool bits 156. In the example illustrated, the storage slots 168 are formed integrally in the first plate 140 of the handle 108 (e.g. machined into the first plate 140) and are open to the first face 116 for inserting, sliding, and removing the bits 156.

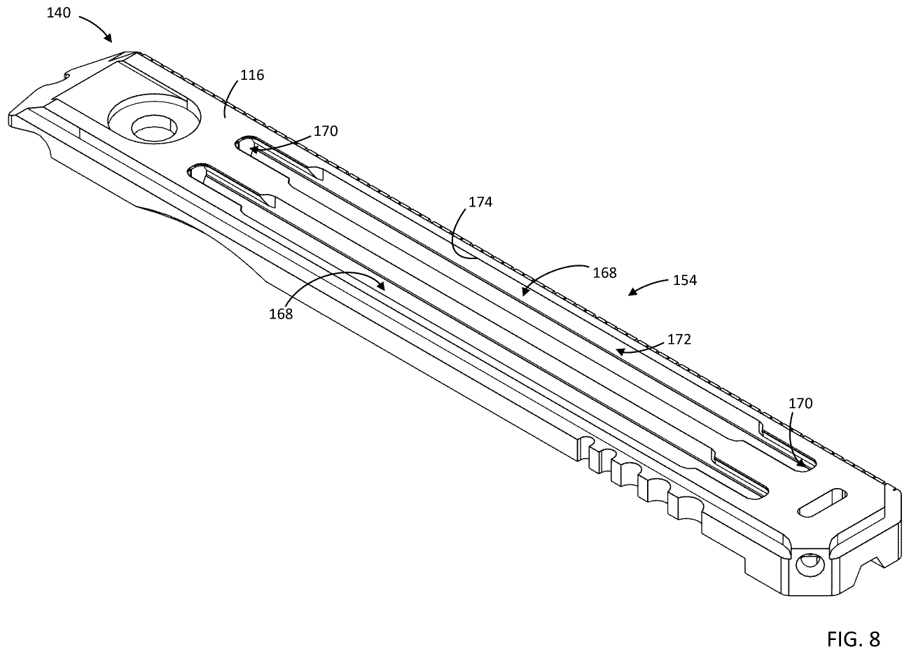

Referring to FIG. 8, in the example illustrated, each slot 168 comprises a slot channel 172 extending between the axially opposite ends 170 of the slot 168. The slot channel 172 extends continuously (i.e. without any interruption) between the axially opposite ends 170 of the slot 168 in the example illustrated. Referring to FIGS. 6 and 7, in the example illustrated, the slot channel 172 has a generally constant cross-sectional profile along its length that generally corresponds in size and shape to that of the bits 156 for receiving the bits 156 therein in close sliding fit to facilitate sliding of the bits 156 along the slot channel 172 between the storage and extraction positions. In the example illustrated, the slot channel 172 has a hex-shaped cross-sectional profile corresponding to that of a standard hex-bit shank (e.g. a 4 mm or ¼-inch hex shank).

Referring to FIG. 8, in the example illustrated, each storage slot 168 has a slot opening 174 extending along the slot channel 172 over the storage and extraction positions. The slot opening 174 is open to the first face 116 of the handle to permit a user to engage the tool bits in the slot channel 172 through the slot opening 174 to facilitate sliding of the tool bits between the storage and extraction positions and removal from the extraction position.

Referring to FIG. 10, in the example illustrated, each slot 168 has an undercut 176 along at least a portion of each storage position so that the slot opening 174 is narrower than the slot channel 172 and the tool bits along at least a portion of each storage position to facilitate retention (and prevent removal) of tool bits in the storage position (see also FIG. 7). Referring to FIG. 11, in the example illustrated, the slot 168 is free of any undercut along the extraction position so that the slot opening 174 is wider than the tool bits along the extraction position to permit removal of the bits from the slot channel 172 when in the extraction position (see also FIG. 6).

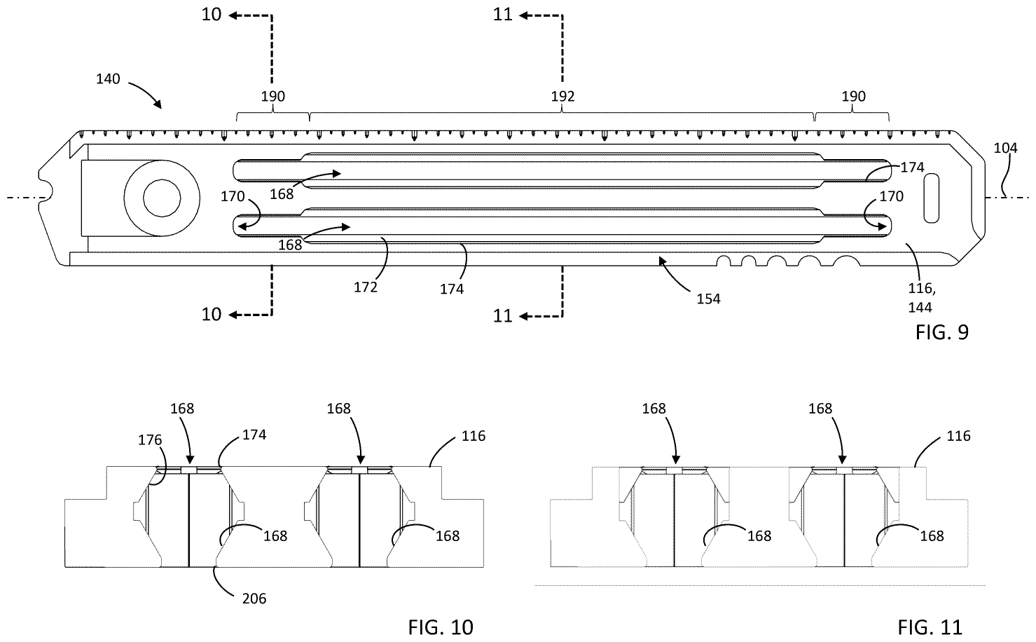

Referring to FIG. 3, in the example illustrated, each tool bit 156 has a bit length along the bit axis 158 between the bit head 160 and shank 162, a bit width laterally across the bit axis 158, and a bit height across the bit axis 158 perpendicular to the bit width. Referring to FIGS. 9 to 11, the slot channel 172 has a channel length along the tool axis 104 between the axially opposite ends 170 of the slot 168, a generally constant internal channel width laterally across the tool axis 104, and a generally constant channel height across the tool axis 104 perpendicular to the channel width. The internal channel width corresponds to the bit width of the tool bits 156 to facilitate insertion and sliding of the tool bits along the slot channel 172. The channel height corresponds to the bit height of the tool bits to permit an entirety (or most) of the tool bit height to be contained within the slot 168 when the tool bit is fully seated in the slot channel 172 (i.e. with only minimal or no portions of the bits protruding out from the channel opening 174 and first face 116 of the handle).

Referring to FIG. 9, in the example illustrated, the slot opening 174 has a pair of storage zones 190 defining respective storage positions and an extraction zone 192 axially intermediate the pair of storage zones 190 and defining the extraction position. Each storage zone 190 of the slot opening 174 has a storage zone length along the tool axis 104 and storage zone width perpendicular to the tool axis 104. The storage zone width is less than the bit width for retaining the bits when in the storage position. In the example illustrated, the storage zone length is less than the bit length, to permit a portion of the bit to project axially from the storage zone 190 into the extraction zone 192, which may facilitate engagement of the bit 156 by the user for sliding toward the extraction position (see also bits 156a in FIG. 4). In the example illustrated, the extraction zone 192 of the slot opening 174 has an extraction zone length along the tool axis 104 and an extraction zone width perpendicular to the tool axis 104. The extraction zone length is greater than the bit length and the extraction zone width is greater than the bit width to permit insertion and removal of the bits through the extraction zone 192 of the slot opening 174 (i.e. into and out from the extraction position). In the example illustrated, the extraction zone width of the slot opening 174 corresponds to the internal channel width. In the example illustrated, the extraction zone length is at least twice the bit length to permit both bits from a respective slot 168 to be in respective extraction positions simultaneously.

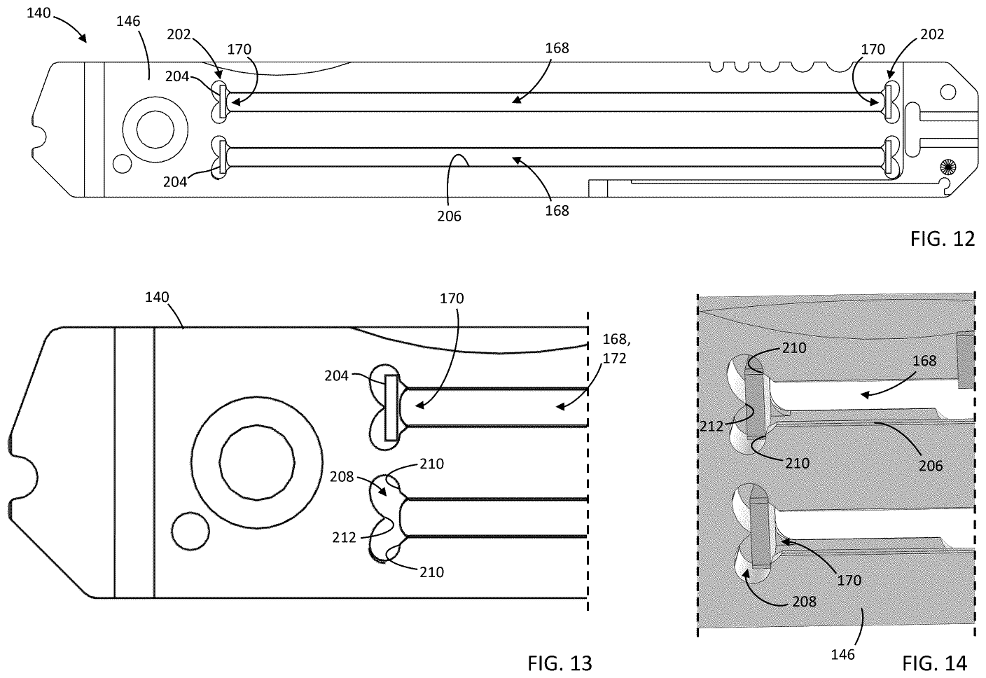

Referring to FIG. 12, in the example illustrated, each end 170 of the slot 168 has a retention mechanism 202 for axially securing a respective bit in the storage position. In the example illustrated, each retention mechanism 202 comprises a respective magnet 204 selected to attract the bit to the storage position while permitting a user to overcome the magnetic attraction to separate the bit from the magnet 204 for movement from the storage position to the extraction position. In the example illustrated, each magnet 204 is mounted at a respective end 170 of the slot 168 in a press fit.

Referring to FIG. 14, in the example illustrated, each slot 168 has an underside opening 206 open to the interior surface 146 of the first plate 140 and opposite the slot opening 174 (FIG. 10). The underside opening 206 is narrower than the bit width along the storage and extraction positions to prevent the bits from passing therethrough when in the slot 168. The underside opening 206 extends along the length of and further axially outboard of the slot opening 174 (FIG. 9) to define a pair of magnet pockets 208 at the axially opposite ends 170 of the slot 168 for receiving respective magnets 204. The magnet pockets 208 are covered (and generally concealed) by the exterior surface 144 (FIG. 9) of the first plate 140 and open to the interior surface 146 (FIG. 12) for receiving respective magnets 204 in press-fit engagement from the underside of the first plate 140. Each magnet pocket 208 is open axially to the slot channel 172 to facilitate magnetic interaction between the magnet 204 and a respective bit 156 when in the storage position.

Referring to FIG. 13, in the example illustrated, each magnet pocket 208 has a press-fit interface for retaining a respective magnet 204 in the pocket 208. In the example illustrated, the press-fit interface comprises a three-point interface having a pair of shoulder surfaces 210 laterally outboard of the underside opening 206 on opposite sides thereof and directed axially away from the channel 172. The shoulder surfaces 210 serve as retaining surfaces (stops) for preventing the magnet 204 from being drawn axially into the slot channel 172 from magnetic attraction when sliding the bit away from the magnet 204 from the storage position toward the extraction position. The press-fit interface further includes a central point surface 212 axially opposite and laterally intermediate the shoulder surfaces 210, and directed toward and in lateral alignment with the channel 172. The central point surface 212 can be spaced axially apart from the pair of shoulder surfaces 210 by slightly less than a thickness of the magnet 204 to facilitate press-fit engagement of the magnet axially between the central point surface 212 and the pair of shoulder surfaces 210. Such a three-point press-fit interface and corresponding geometry can help simplify some aspects of manufacturing by, for example, reducing the tooling requirements (e.g. variety of tool sizes required) for milling the slot 168 and pockets 208 into the first plate 140.

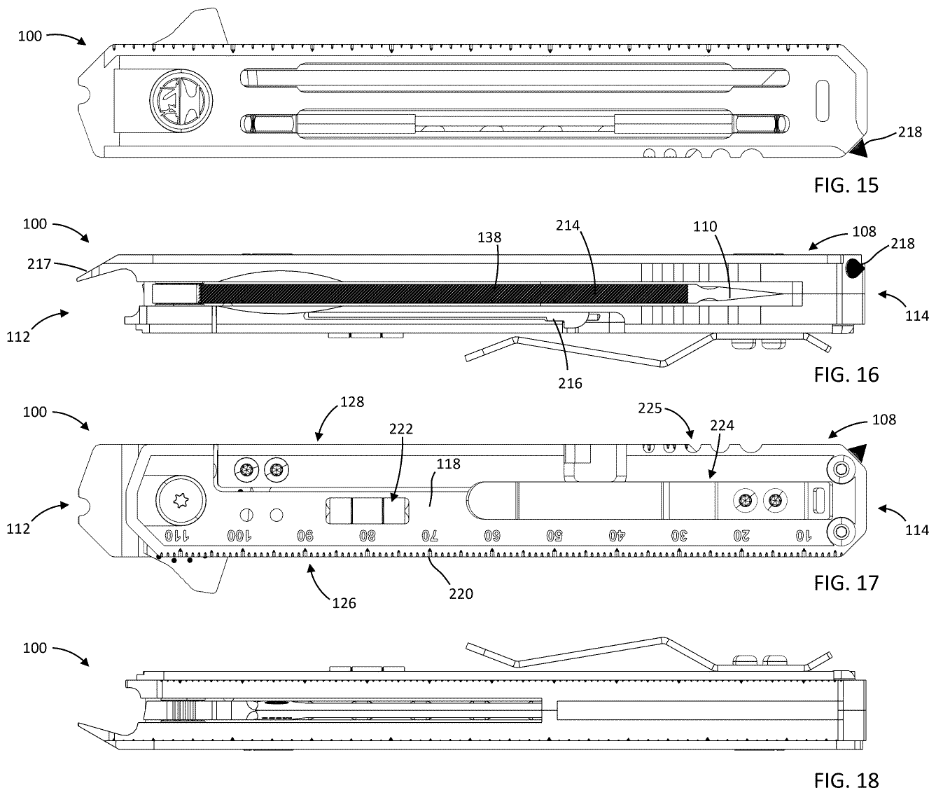

Referring to FIGS. 15 to 18, in the example illustrated, the multitool 100 includes a plurality of additional tools and accessories. Referring to FIG. 16, the multitool 100 includes a material file 214 formed integrally along the spine 138 of the blade 110, which can also serve to enhance grip. The multitool 100 further includes tweezers 216 (shown schematically) slidingly received in the handle 108. The multitool 100 further includes a pry bar 217 (which can serve as a bottle opener and a nail puller via a nail puller opening in the leading edge of the pry bar 217) at the head end 112 of the handle 108, and can be used when the blade 110 is stowed and clear of the pry bar 217. A window/glass breaker point 218 projects from a corner of the butt end 114 of the handle 108. Referring to FIG. 17, the back edge 126 can serve as a ruler and has ruler markings 220 etched along the back edge 126 and second face 118 of the handle 108 (and optionally along the spine 138 of the blade 110 to extend ruler length when the blade 108 is in the deployed position). The multitool 100 further includes a bubble level 222 integrated into the handle 108 and viewable on the second face 118 of the handle 108. The bubble level 222 is oriented parallel to the belly edge 128 of the handle 108, which is flat and free of any protrusions when the blade is in the stowed position to serve as the reference edge (base) for the bubble level 222. The multitool 100 further includes a belt clip 224 fastened to the second face 118 of the handle 108 to enhance usability and stowability of the multitool 100. The belt clip 224 is switchable between two positions by fastening the clip 224 to either a first pair of fastener apertures in the second face 118 of the handle 108 toward the butt end 114 of the handle 108 (as shown in FIGS. 17), or a second pair of fastener apertures in the second face 118 of the handle 108 toward the head end 112 of the handle 108. The multitool 100 further includes a wire stripper 225 formed integrally along the belly edge 128 of the handle, and which includes a plurality of axially spaced apart grooves for stripping wires of various sizes (e.g. up to 12 AWG wire).

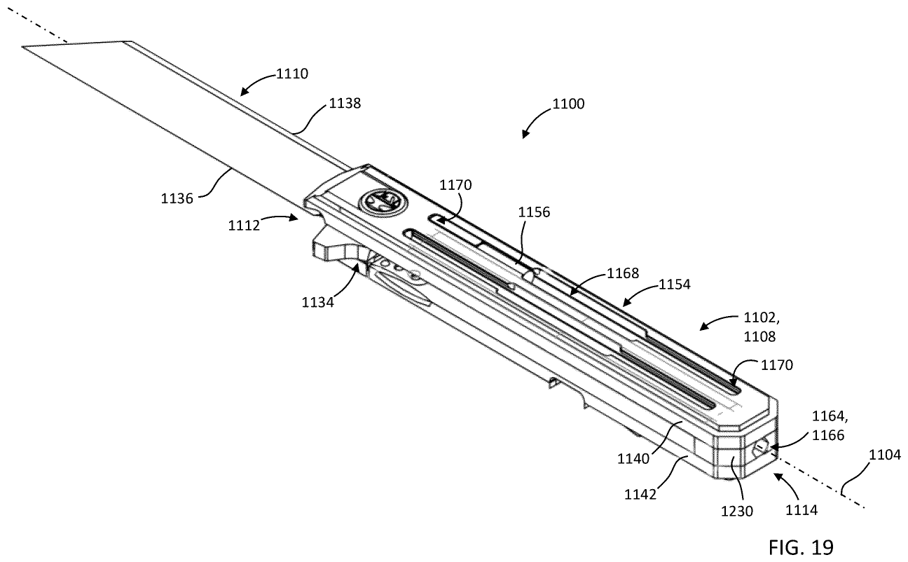

Referring to FIG. 19, another example multitool 1100 is shown. The multitool 1100 has similarities to the multitool 100, and like features are identified using like reference numerals, incremented by 1000.

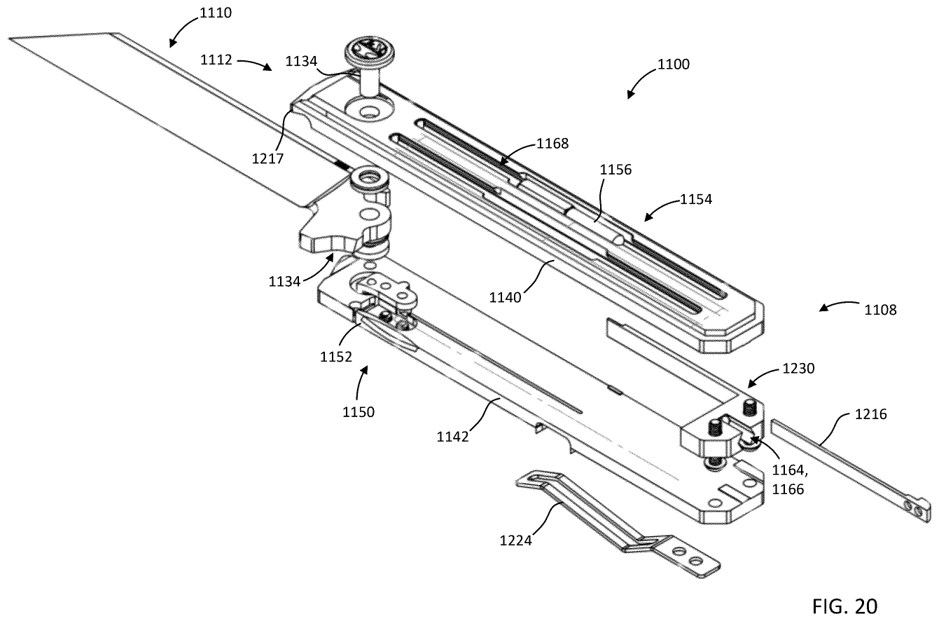

In the example illustrated, the multitool 1100 has a body 1102 extending along a tool axis 1104. The body 1102 comprises a pair of first and second plates 1140, 1142 on opposite sides of the body 1102 and forming a handle 1108 of the multitool 1100. The plates 1140, 1142 can be formed of metal (e.g. titanium). In the example illustrated, the first plate 1140 includes an integrated bit retainer 1154 for storing a plurality of tool bits 1156. The bit retainer 1154 includes one or more bit storage slots 1168. Each bit storage slot 1168 is configured to retain a respective pair of tool bits 1156 at axially opposite ends 1170 of the slot 1168. In the example illustrated, the bit retainer 1154 includes a pair of the storage slots 1168 for storing four tool bits. Each tool bit 1156 is selectively slidable along a respective slot 1168 from a storage position (shown in FIG. 19 for bit 1156) to an extraction position (shown in FIG. 20 for bit 1156). In the storage position, the bit 1156 is adjacent a respective end 1170 of the slot 1168 and securely retained in the slot 1168. Referring to FIG. 20, in the extraction position, the bit 1156 is moved toward the center of the slot 1168 relative to the storage position and is removable from the slot 1168 in the extraction position for insertion into a bit holder 1164 of the multitool 1100 for use.

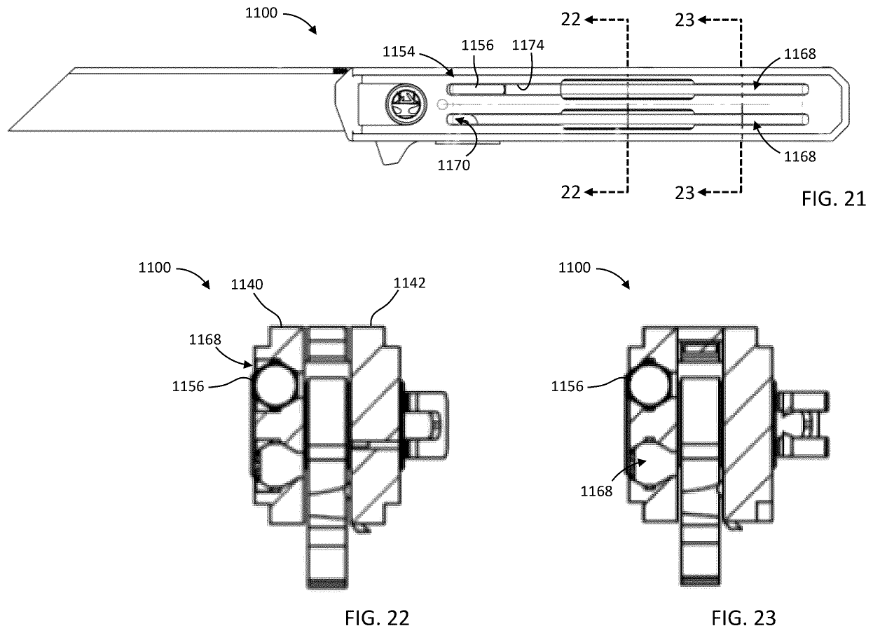

Referring to FIG. 21, in the example illustrated, the slot 1168 has a slot opening 1174 extending therealong for insertion and removal of the tool bits 1156 and engagement of the tool bits 1156 by the user for movement between the storage and extraction positions. In the example illustrated, the slot opening 1174 is narrower than the tool bits 1156 along at least a portion of the respective storage positions for retaining the tool bits 1156 within the slot 1168 when in the storage positions (i.e. to prevent the tool bits from falling out of the slot 1168). The slot opening 1174 is wider than the tool bits 1156 along the extraction position to permit removal of the bits 1156 from the slot 1168 when in the extraction position. In the example illustrated, each slot 1168 has a common extraction position for each bit 1156 of the pair of tool bits 1156 retainable in the slot 1168, and only one of the bits 1156 retained in the slot 1168 can occupy the extraction position at one time. The slot opening 1174 along the common extraction position is sized to have an extraction zone length that is less than twice the bit length to accommodate only one bit 1156 at a time in the common extraction position of the slot 1168. In the example illustrated, each end of the slot 1168 has a respective retaining mechanism in the form of a magnet to attract the tool bits 1156 into respective storage positions.

Referring to FIG. 22, the first plate 1140 has a thickness selected as a minimum viable thickness for containing the bit height of the driver bits, and the thickness of the second plate 1142 can be selected to match that of the first plate 1140. For the selected plate material (e.g. metal, titanium, etc.) the thickness of these plates 1140, 1142 can be selected to balance acceptable durability and overall strength while maintaining the ability to contain/retain the bits 1156. The thickness of the first plate 1140 can also be relevant with respect to bit retention, as the cut out area of the slot 1168 corresponding to the extraction position from which bits can be extracted (through the bit extraction zone of the slot opening) by the user can present a small amount of material flex which would not be present with thicker material. This small amount of material flex may facilitate extraction of the bits 1156 by the user in some examples, while inhibiting the bits 1156 from coming loose/falling out of the bit retainer during normal storage of the multitool 1100.

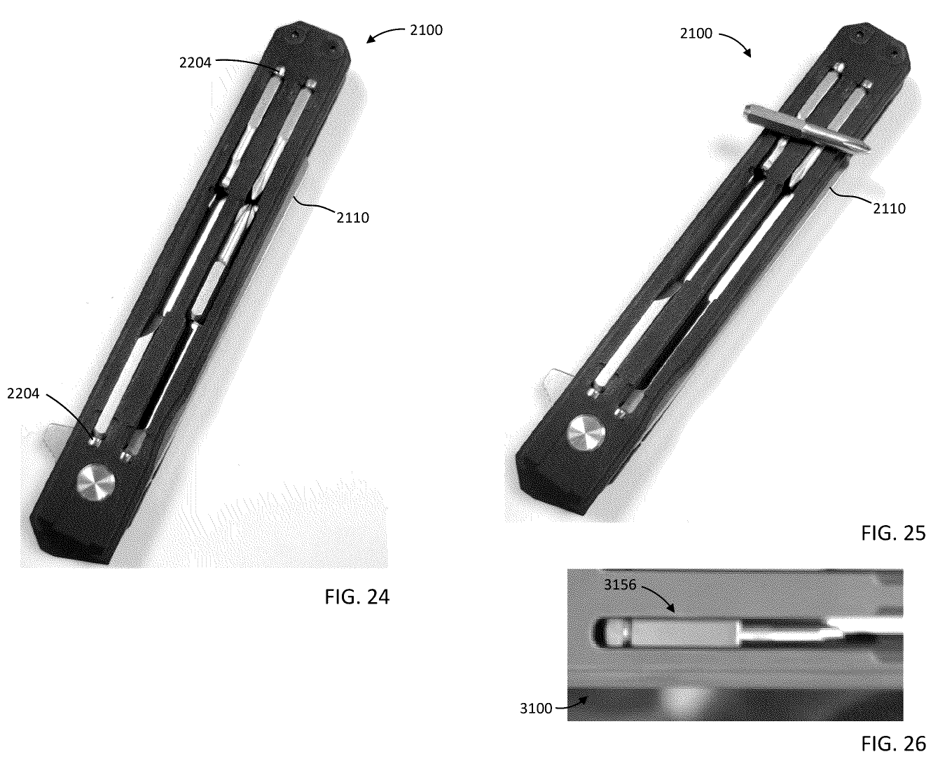

Referring to FIG. 21, in the example illustrated, four magnets are embedded in the first plate 1140 at respective ends 1170 of the slot 1168. The magnets can be adhered (e.g. glued), fastened, or otherwise secured at respective ends 1170 of the storage slots 1168 during assembly (e.g. press fit like magnets 204 of multitool 100 and/or attached like magnets 2204 shown in FIG. 24 for multitool 2100). The magnets attract standard driver bits to facilitate their retention in respective storage positions within the bit retainer 1154 formed within the first plate 1140, while accommodating removal of the bits when desired.

Referring to FIGS. 22 and 23, in some examples, the shape of the bit retention profile of the storage slots 1168 can present a minimum viable amount of material for retaining the bits 1156, while permitting for ease of use, and sliding of the bits 1156 along respective slots 1168 for retention adjacent an end of the slot 1168 where the magnets are located to help retain the bits 1156 therein.

Referring to FIG. 19, in the example illustrated, the multitool 1100 is configured as a pocket knife with at least one tool of the multitool 1100 comprising a knife blade 1110 that can be stowed in (e.g. folded into) the handle 1108 (see e.g. FIGS. 24 and 25, showing an example blade 2110 of multitool 2100 in a stowed position). When stowed, the blade 1110 extends lengthwise over most of the length of the multitool handle 1108, and presents no sharp edges to the user. The spine 1138 (i.e. trailing or non-leading edge) of the blade 1110 opposite the sharp cutting edge 1136 can present a material file. The blade 1110 can lock into the handle 1108 of the tool 1100 and pivot at one end around a smooth bearing.

In the example illustrated, the blade 1110 terminates in the handle 1108 at its captured end (tang portion 1130), and is positioned generally parallel with the handle 1108. The first and second plates 1140, 1142 sandwich the tang portion 1130 of the blade 1110 and portions of the bit holder 164 for receiving bits for use. Referring to FIG. 20, the tang portion 1130 is pivotably coupled to the handle 1108 and held by two bearings, whose major faces are likewise parallel to the tang portion 1130 of the blade 1110 and permit a locking pivot pin 1134 to pass through the bearings, tang portion 1130, and handle 1108 to keep the assembly in place. The pivot pin 1134 may take the form of a press-fit smooth pin, a textured pin, or a chicago-style screw. On each end of the pivot pin 1134, a logo can be provided. This can add a small amount of texture and grip to the head of the pivot pin 1134, and can help prevent a third party pin to be mistaken for the intended pin, which can be important for proper operation of the blade 1110 and safety reasons. The pin 1134 passes through a counterbore on both of the first and second plates.

In the example illustrated, the handle 1108 has a lock 1150 for selectively locking the blade 1110 in and unlocking the blade from the deployed position. In the example illustrated, the lock 1150 is in the form of a frame lock integrated into the second plate 1142 to provide biasing spring tension to a locking bar 1152 for the blade 1110, via a frame lock cutout in the second plate 1142. When fully extended/deployed, the blade 1110 can be locked in position by the locking bar 1152, to prevent unwanted closure of the blade 1110 back toward the stowed position. The second plate 1142 can be generally symmetrical with the first plate 1140 to provide symmetry to the handle 1108. In the example illustrated, the second plate 1142 is sectioned roughly half its length by the frame lock cutout to form the locking bar 1152, which is be bent after machining to set spring tension for the locking bar 1152. In some examples, the frame lock cutout can extend at least half the length of the second plate 1142 to present suitable spring tension for the locking bar 1152. The spring tension of the locking bar 1152 can be adjusted by machining the frame lock cutout to be either shorter (for more spring tension) or longer (for less spring tension and more flexibility), and subsequently bending the locking bar 1152 after formation. In some examples, the frame lock cutout can have a length of up to 60% of the length of the second plate 1142. The lock 1150 can further retain the blade in the stowed position with a detent.

In the example illustrated, the blade 1110 is constructed of metal. In some examples, the blade 1110 can be formed of a hard, corrosion resistant, high durability, edge-keeping steel, such as MAGNACUT, M390, S30V or a similar metal, and can include a higher degree of chromium, vanadium, and niobium—which may all improve its performance in comparison to standard steel. In the example illustrated, the blade 1110 comes to a sharp point at a near 45 degree angle in the tip, sometimes referred to as reverse tanto style, or sheep's foot style. The blade 1110 sweeps cleanly back on a sharpened edge to a flat trailing edge (spine) of the blade 1110 which can contain the file. The steel of the blade 1110 in this area can be carved by machine to create small ridges which serve as the file. These ridges may either be in the straight row configuration or in a chevron or mixed chevron knurled configuration to provide different textures of file, which can also serve to enhance grip of the knife blade 1110 and improve safety in use.

The second plate 1142 can further include attachment points for a clip 1224 for clipping the multitool when not in use (e.g. to a belt or pocket). In the example illustrated, the clip 1224 is secured to the second plate 1142 via two small screws, and can be cut, stamped, or otherwise constructed to have natural tension when secured to the second plate 1142, enabling it to hold securely to, for example, a belt or pocket of the user. The clip 1224 can have a bend in the form of a small further protrusion of the clip 1224 which enables the user to more easily slide the clip 1224 into place. The clip 1224 is positioned “behind” (axially away from the blade 1110) the frame lock cutout so that the screw holes for mounting the clip 1224 do not interfere with the structural integrity of the second plate 1142 adjacent the frame lock cutout.

Referring to FIG. 19, in the example illustrated, the first plate 1140 and the second plate 1142 sandwich the tang portion 1130 of the knife blade 1110 at the head end 1112 of the handle 1108 (from which the blade 1110 projects when deployed), and further sandwich a bit holder piece 1230 at the butt end 1114 of the handle 1108 axially opposite the head end 1112. The bit holder piece 1230 has a similar thickness to the captured tang portion 1130 of the blade 1110, and allows the tool 1100 to be generally flat and symmetrical, and for the blade 1110 to open/operate smoothly.

The general symmetry of the handle 1108 (comprising the first and second plates 1140, 1142) enable the bit retainer 1154 to be optionally integrated into both the first plate 1140 as well as the second plate 1142 of the handle 1108 in some examples. In such examples, the clip 1224 (FIG. 20) can be removed to reduce obstructions to the additional bits stored in a second bit retainer in the second plate.

In the example illustrated, the tang portion 1130 of the blade 1110 is left unsharpened and at full thickness, and can include a protrusion serving as a “catch” for the operator's finger to facilitate movement of the blade 1110 between the deployed and stowed positions, and to serve as a small guard against injury of the fingers. The design of this protrusion can be smooth and effective in operating the blade, without causing the element to hinder storage or otherwise affect ergonomic operation of the tool.

In the example illustrated, the butt end 1114 of the handle 1108 contains the bit holder 1164, in the form of a bit socket 1166 for receiving the shank of any one of the plurality of bits 1156 stored in the bit retainer 1154. The bit socket 1166 can be hex-shaped for receiving a standard screwdriver hex-bit—such as the four bits housed in the bit retainer of the multitool which can be hex bits with a corresponding hex-shaped shank. The bit holder piece 1230 sandwiched between the first and second plates 1140, 1142 is set flush with the surrounding geometry of the first and second plates 1140, 1142 to present a smooth surface and prevent snags during storage and handling. The bit socket 1166 is generally coaxial with the longitudinal tool axis 1104 defined by the handle 1108, and the handle 1108 (albeit with a rectangular cross-sectional profile) is relatively symmetric about the axis 1104 for improved rotational ergonomics when using a bit 1156 installed in the bit socket 1166. Referring to FIG. 20, in the example illustrated, the full bit socket 1166 is formed by machining fully through the bit holder piece 1230, and partially into each of the first and second plates 1140, 1142.

In the example illustrated, the first and second plates 1140, 1142 and bit holder piece 1230 are secured to each other with a pair of screws which pass through the second plate 1142 and bit holder piece 1230 and into respective threaded holes in the first plate 1140. The screws are positioned so as not to interfere with the bit retainer 1154. The bit holder piece 1230 can be formed of metal (e.g. titanium), composite, or a plastic (e.g. hard plastic) capable of adequately holding driver bits therein for use.

In the example illustrated, one of the standard bits that can be included with the multitool 1100 can be a custom pen tip built into the shape of a standard hex bit (i.e. having a pen tip for marking and a standard hex shank, like the example pen bit 3156 shown in FIG. 26 in a storage position for multitool 3100). It is possible by replacement of any, all, or some of the bits to customize the multitool 1100, as the bit retainer 1154 can enable the fitment of a wide range of possible bits. Example tool bits include:
Torx bits
Shaped torx bits
Flat head bits
Phillips bits
Pen/writing bits
Pointed/puncture/punch bits
Tri-head/pentalobe non-standard bits
Magnetic grasping bits
Security bits
Robertson bits
Scribe bits
Hex driver bits
Magnetic bits

In the example illustrated, the bits 1156 are standard, interchangeable driver bits. In some examples, compact bits can be used, which can be flattened such that their thickness is the same as the small bits but with a larger/wider driver head. In some examples, the base of each bit can contain a notch to facilitate extraction by the user—e.g. by enabling a fingernail to catch on the notch for sliding and extraction from the body. In some examples, such a notch may optionally also facilitate securing of the bit in the storage positions within the bit retainer and/or in the bit holder/socket (e.g. through detents). In some examples, the multitool 1100 can stow a first set of bits (e.g. four bits) on one side of the handle 1108 (e.g. in the first plate 1140), and optionally also on the other side of the handle 1108 (e.g. by replacing the second plate 1142 with one having an integrated bit retainer 1154) to expand bit capacity of the multitool 1100.

Referring to FIG. 20, in the example illustrated, a pair of tweezers 1216 (shown schematically) can be secured by a protrusion on its miniature handle fully within one side of the bit holder piece 1230. By catching on a fingernail, the protrusion can enable the tweezers 1216 to be conveniently removed from the main body of the tool and used individually.

In the example illustrated, the first plate 1140 has a prybar 1217 formed integrally at the head end of the first plate 1140. By placing a lip of the prybar 1217 underneath a bottle cap or pryable surface, the cap or surface can be manipulated with force applied by the user through movement of the handle as a lever.

A ruler can be provided (e.g. scribed or etched with a laser) along a length of the blade 1110 and/or handle 1108, to enable measurement out to around, for example, 6 inches (150 mm). Regular hatches can be etched or carved into the body of the tool either by, for example, laser or CNC machine.

Aspects of the present teachings are directed to a feature-rich multitool which can be in the form of a high quality pocket knife, and a housing for this pocket knife which contains additional tools, including a retainer for multiple tool bits which can be inserted one at a time into a bit socket/holder integrated into the handle in order to transform the tool into a bit driver, and/or optionally to accept any other standard hex bit.

The novel design of the bit retainer formed in the first plate, as well as that of the opposing second plate, can create a roughly rotationally symmetric handle which can improve upon a common industry problem of asymmetrical bit drivers in some other multitool designs, which can often compromise their construction by inserting knives, pliers, scissors, or other tools and accessories into the main body of the knife in such a way as to hinder the performance of the multitool as a bit driver. The shape and positioning of key elements, balancing of weights and placements of fasteners within this device can contribute to its overall shape and generally axisymmetric design. This design can, for example, enhance the speed and comfort with which driver bits can be turned using the handle, which can help improve usability of the multitool as a bit driver. As a pocket knife, the file/knurling on the spine of the blade can provide enhanced grip and can encourage safe operation throughout the life of the tool, while also functioning as a file. Taken together, the many individual components of this multi-tool are positioned in a novel and space-efficient manner which may enable it to approach and/or achieve the functions and performance of larger discrete, single-purpose tools.

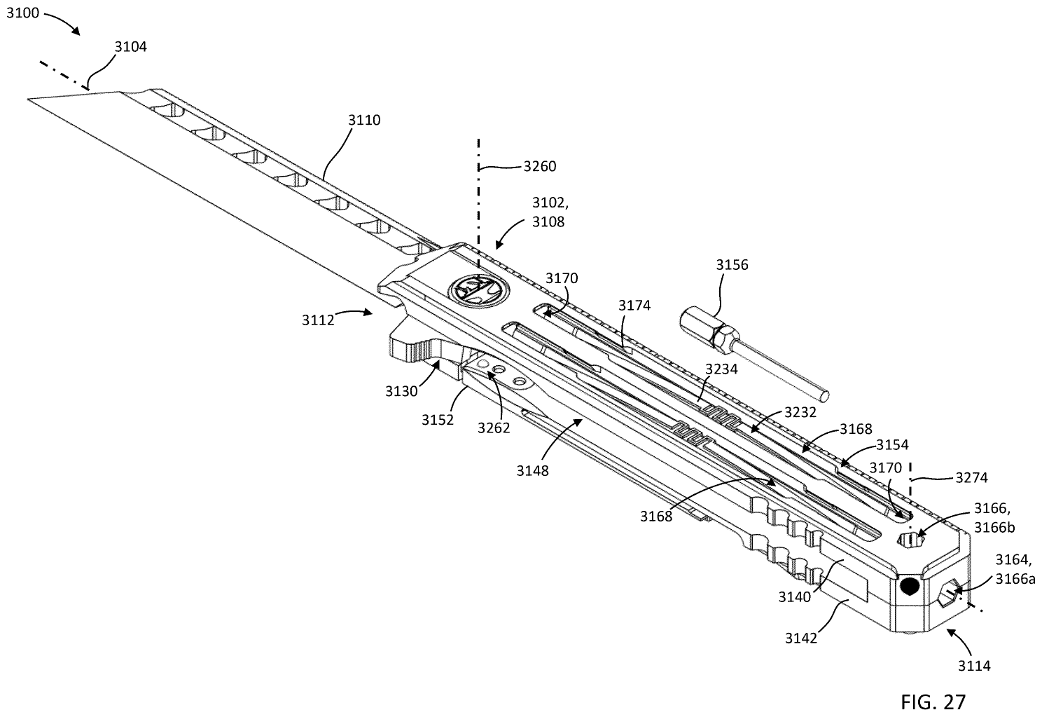

Referring to FIG. 27, another example multitool 3100 is shown. The multitool 3100 has similarities to the multitool 1100, and like features are identified using like reference numerals, incremented by 2000.

In the example illustrated, the multitool 3100 has a body 3102 extending along a tool axis 3104. The body 3102 defines a handle 3108 of the multitool 3100. In the example illustrated, the handle 3108 is formed from a pair of parallel plates 3140, 3142. The handle 3108 has an integrated bit retainer 3154 for storing a plurality of tool bits 3156 (a simplified example of one being shown in FIG. 27). In the example illustrated, the bit retainer 3154 includes a pair of bit storage slots 3168 extending along the tool axis and spaced laterally apart from each other. Each bit storage slot 3168 is configured to retain a respective pair of tool bits 3156 at axially opposite ends 3170 of the slot 3168. Each tool bit 3156 is selectively slidable along a respective slot 3168 from a storage position adjacent a respective end 3170 of the slot 3168 and in which the bit 3156 is retained within the slot 3168, to an extraction position toward the center of the slot 3168 relative to the storage position and from which the bit 3156 is removable from the slot 3168 for insertion into a bit holder 3164 of the multitool 3100 for use.

In the example illustrated, the slot 3168 has a slot channel extending between the axially opposite ends 3170 of the slot 3168. The slot channel has a generally constant cross-sectional profile corresponding in size and shape to that of the bits 3156 for receiving the bits 3156 therein in close sliding fit for sliding along the slot channel between the storage and extraction positions. In the example illustrated, the slot 3168 has a slot opening 3174 extending along the slot channel for insertion and removal of the tool bits 3156 and engagement of the tool bits 3156 by the user for sliding between the storage and extraction positions. The slot opening 3174 is narrower than the tool bits 3156 along at least a portion of the respective storage positions for retaining the tool bits 3156 within the slot 3168 when in the storage positions. The slot opening 3174 is wider than the tool bits 3156 along the extraction position to permit removal of the bits 3156 from the slot 3168 when in the extraction position.

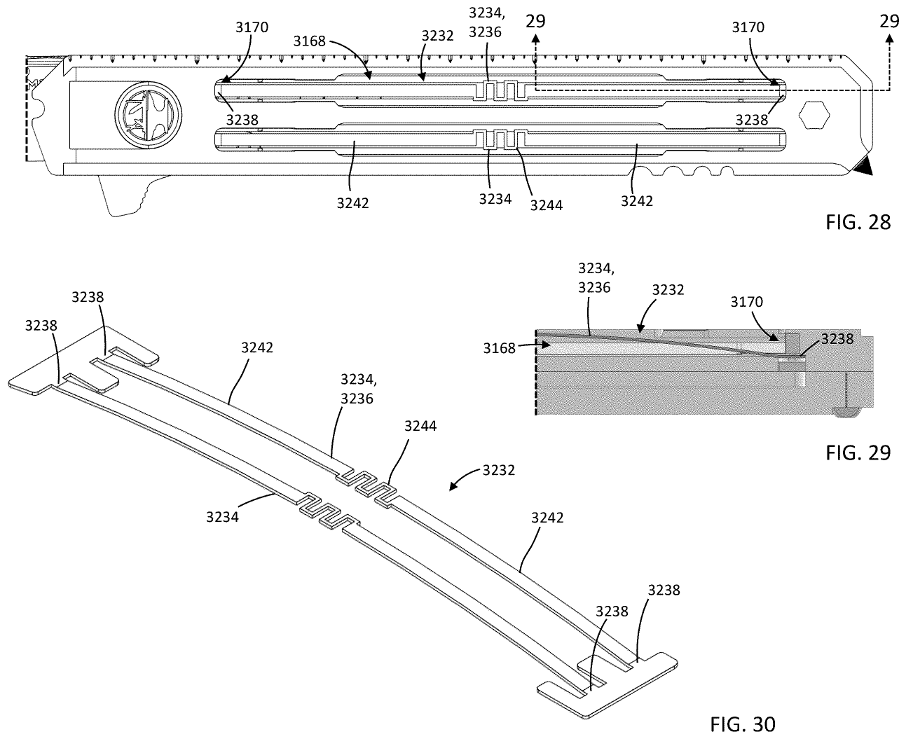

In the example illustrated, the bit retainer 3154 includes a spring-loaded ejector 3232 having at least one spring 3234 in each slot 3168 for urging ejection of each bit 3156 from the slot 3168 when the bit 3156 reaches the extraction position. Referring to FIGS. 28 to 29, in the example illustrated, the at least one spring 3234 comprises a leaf spring (e.g. single-leaf spring) having a spring body 3236 extending axially along the slot 3168 between axially opposite spring ends 3238 fixed relative to respective ends 3170 of the slot 3168. The spring body 3236 arches along the slot 3168 between the spring ends 3238 with an apex of the spring body 3236 axially centered along the slot 3168 in the extraction position for exerting a lifting spring force on an underside of the bit 3156 when in the extraction position to facilitate ejection of the bit 3156 from the slot 3168. In the example illustrated, the spring body 3236 further exerts the lifting force on the bits 3156 when moving toward and positioned in respective storage positions to facilitate retention of the bits 3256 in the slot 3168 (e.g. through urging of the bits 3256 into frictional engagement the ceiling of the slot 3168 along the storage position). Referring to FIG. 30, in the example illustrated, the spring body 3236 has a pair of spring segments 3242 extending axially in opposite directions and downwardly from the apex toward respective spring ends 3238 (and slot ends 3170) for engaging and exerting the lifting force on respective bits 3256. The spring body 3236 further has a serpentine segment 3244 at the apex between and joining the pair of spring segments 3242 to accommodate downward deflection of both spring segments 3242 simultaneously (e.g. to overcome reactive bulging in one spring segment 3242 in response to downward deflection of the other spring segment 3242 to allow for both bits 2156 to be inserted into respective storage positions).

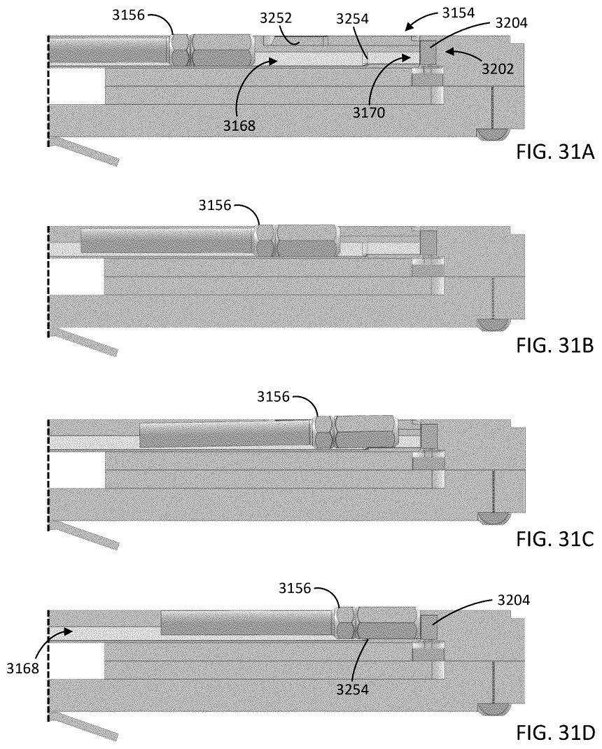

Referring to FIGS. 31A-31D, in the example illustrated, the bit retainer 3154 has a respective retention mechanism 3202 in the slot 3168 adjacent each storage position for axially securing the bit 3156 in the storage position. In the example illustrated, the retention mechanism 3202 comprises a magnet 3204 at each end 3170 of the slot 3168 to attract and retain each tool bit 3156 in its respective storage position (shown in FIG. 31D). In the example illustrated, the retention mechanism 3202 further includes a snap-in seat for each bit 3156. In the example illustrated, the snap-in seat comprises an upper protrusion surface 3252 projecting downwardly from a ceiling of the slot 3168 to urge the bit 3156 downward against the spring force of the spring body 3236 (omitted from FIGS. 31A-31D) as the bit 3156 is slid along the slot 3168 from the extraction position (FIG. 31A) toward the storage position (FIG. 31D), and a lower ramp surface 3254 spaced axially inward from the upper protrusion surface 3252 toward the end 3170 of the slot 3168 for elevating the bit 3156 after clearing the upper protrusion surface 3252 to facilitate axial retention of the bit 3156 in the storage position. Referring to FIG. 31D, in the example illustrated, when on the lower ramp surface 3254, a side portion of the shank of the bit 3156 projects transversely out from the slot 3168 to facilitate engagement of the bit 3156 by a user for sliding back toward the extraction position.

Referring to FIG. 27, in the example illustrated, the multitool 3100 includes a knife blade 3110 pivotable between a deployed position, in which the blade 3110 projects from the head end 3112 of the handle 3108 along the tool axis 3104, and a stowed position, in which the blade 3110 is stowed in (e.g. folded into) a blade cavity 3148 defined by the handle 3108 (between the plates 3140, 3142). In the example illustrated, the blade 3110 has a tang portion 3130 retained between the plates 3140, 3142. The tang portion 3130 is pivotably coupled to the handle 3108 through a pivot pin for pivoting of the blade 3110 between the stowed and deployed positions about a blade pivot axis 3260 adjacent the head end 3112 of the handle 3108.

In the example illustrated, the handle 3108 has a lock for selectively locking the blade 3110 in and unlocking the blade from the deployed position (shown in FIG. 27). In the example illustrated, the lock is in the form of a frame lock integrated into the plate 3142 to provide biasing spring tension to a locking bar 3152 for the blade 3110, via a frame lock cutout in the plate 3142. When deployed, the blade 3110 can be locked in position by the locking bar 3152, to prevent unwanted closure of the blade 3110 back toward the stowed position. To unlock the blade 3110, the locking bar 3152 is deflected outwardly away from the blade cavity 3148 clear of the tang portion 3130 to permit pivoting of the blade 3110 back toward the stowed position.

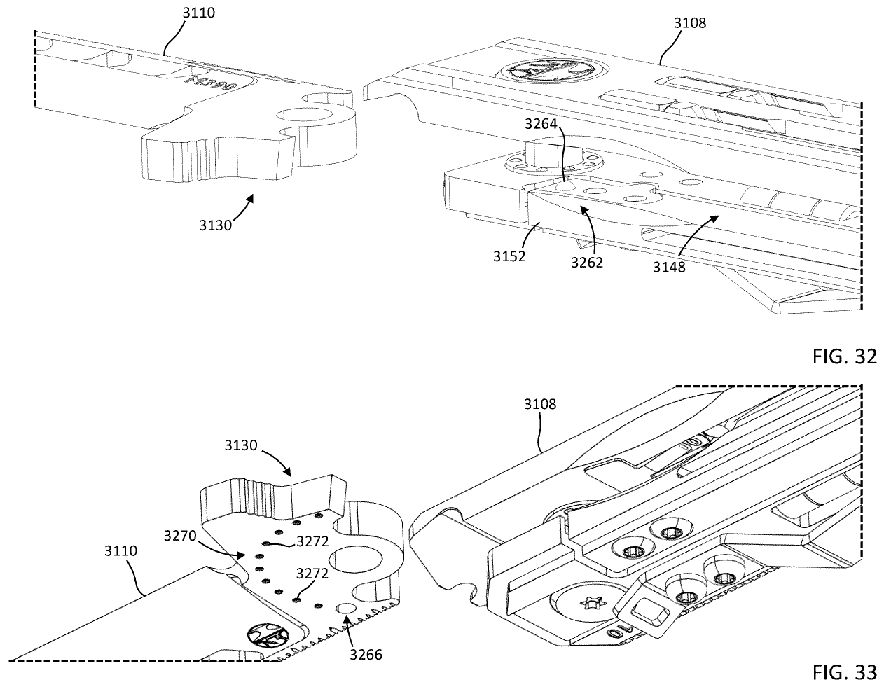

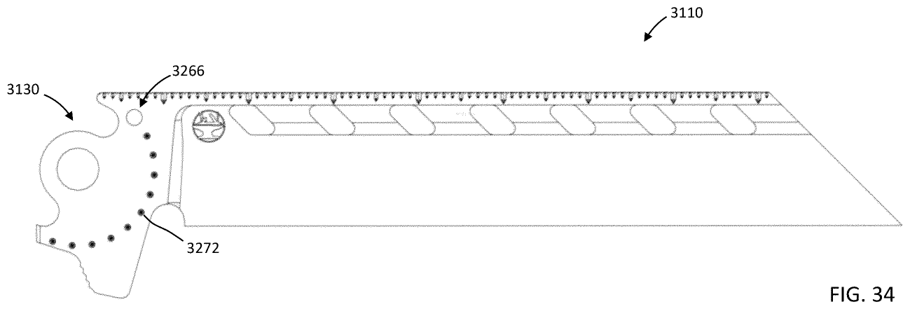

In the example illustrated, the multitool 3100 further includes a detent mechanism 3262 for releasably retaining the blade 3110 in the stowed position, and releasing the blade 3110 when a sufficient opening force is applied for pivoting the blade 3110 toward the deployed position. Referring to FIGS. 32 and 33, in the example illustrated, the detent mechanism 3262 includes a detent ball 3264 projecting from an interior surface of the handle 3108 into the blade cavity 3148, and a locking dimple 3266 on the tang portion 3130 of the blade 3110 and positioned for receiving the detent ball 3264 when the blade 3110 reaches the stowed position. In the example illustrated, the detent ball 3264 projects from the locking bar 3152 and is urged inwardly toward the blade cavity 3148 for seating in the locking dimple 3266 by the biasing spring tension of the locking bar 3152.

In the example illustrated, the detent mechanism 3262 further includes an indexing system 3270 for releasably retaining the blade 3110 in a plurality of intermediate positions between the stowed and deployed positions. Each intermediate position can correspond to a predetermined angular position of the blade 3110 relative to the handle 3108 about the blade pivot axis 3260 (FIG. 27), which can allow the blade 3110 to be used for angle measurement (e.g. to provide bevel gauge/protractor functionality). In the example illustrated, the indexing system 3270 includes a plurality of indexing dimples 3272 (ten, in the example illustrated) formed in the tang portion 3130 of the blade 3110 and spaced circumferentially apart from each other about the blade pivot axis 3260 (FIG. 27) by predetermined angular spacings. The indexing dimples 3272 are in radial alignment with the detent ball 3264 (and the locking dimple 3266) relative to the blade pivot axis 3260 for receiving the detent ball 3264 when the blade 3110 reaches respective intermediate positions. In the example illustrated, the indexing dimples 3272 are spaced circumferentially apart from each other and the locking dimple 3266 about the blade pivot axis 3260 by a predetermined pitch angle. The pitch angle can be, for example, 15 degrees, to provide for angular stops and measurements between 0 and 180 degrees in 15-degree intervals. In the example illustrated, the indexing dimples 3272 are shallower than the locking dimple 3266 to provide for relatively lighter detent resistance in each intermediate position relative to the detent resistance in the stowed position for the locking dimple 3266, which is deeper relative to the indexing dimples 3272 to releasably retain the blade 3110 in the stowed position more securely.

Referring to FIG. 27, in the example illustrated, the multitool 3100 includes a plurality of bit holders 3164 integrated into the handle 3108. In the example illustrated, each bit holder 3164 is in the form of a bit socket 3166 for receiving the shank of any one of the plurality of bits 3156 stored in the bit retainer 3154. In the example illustrated, the multitool 3100 includes a first bit socket 3166a at the butt end 3114 of the handle 3108 axially opposite the head end 3112. The first bit socket 3166a is coaxial with the tool axis 3104 for operating a driver bit inserted in the first bit socket 3166a by rotating the multitool 3100 about the tool axis 3104. In the example illustrated, the multitool 3100 includes a second bit socket 3166b in the side face of the handle 3108 to which the storage slots 3168 are open. The second bit socket 3166b is oriented perpendicular to the tool axis 3104 (and normal to the side face) for operating a driver bit inserted in the second bit socket 3166 by rotating the multitool 3100 about a socket axis 3274 of the bit socket 3166b oriented normal to the side face, which can provide for increased torque output relative to the first bit socket 3166a. In the example illustrated, the second bit socket 3166b is adjacent the butt end 3114 of the handle 3108 axially intermediate the storage slots 3168 and the butt end 3114.

1. A multitool comprising:
a) a handle extending along a tool axis;
b) at least one tool movably mounted to the handle, each tool movable relative to the handle between a deployed position in which the tool projects from the handle for use, and a stowed position in which the tool is nested in the handle; and
c) a bit retainer integrated into the handle for storing a plurality of tool bits, the bit retainer including one or more bit storage slots, each slot for storing a respective pair of tool bits at axially opposite ends of the slot, each tool bit selectively slidable along a respective slot from a storage position adjacent a respective end of the slot in which the bit is securely retained in the slot, to an extraction position toward a center of the slot from which the bit is removable from the slot for insertion into a bit socket of the multitool for use.

2. The multitool of claim 1, wherein the bit retainer comprises a plurality of bit storage slots spaced laterally apart and extending parallel to each other for retaining respective pairs of tool bits.

3. The multitool of claim 1, wherein the slot comprises a slot channel extending between the axially opposite ends of the slot, the slot channel having a cross-sectional profile corresponding generally in size and shape to that of the bits for receiving the bits therein in close sliding fit for sliding along the slot channel between the storage and extraction positions.

4. The multitool of claim 3, wherein the slot comprises a slot opening extending along the channel over the storage and extraction positions to permit engagement of the tool bits by a user to facilitate the sliding between the storage and extraction positions and removal from the extraction position.

5. The multitool of claim 4, wherein the slot opening is narrower than the slot channel and the tool bits along at least a portion of each storage position for retaining the tool bits within the slot channel in the storage positions, and the slot opening is wider than the tool bits along the extraction position to permit removal of the bits from the slot channel when in the extraction position.

6. The multitool of claim 5, wherein the slot channel has a channel length between the axially opposite ends of the slot and a generally constant internal width along the channel length, the internal width corresponding to a bit width of the tools bits to facilitate insertion and sliding of the tool bits along the channel.

7. The multitool of claim 4, wherein the slot opening has a pair of storage zones extending along respective storage positions and an extraction zone extending along the extraction position, each storage zone of the slot opening having a storage zone width that is less than a bit width of the tool bits for retaining the bits when in the storage position, and the extraction zone of the slot opening has an extraction zone length greater than a bit length of the tool bits and an extraction zone width greater than the bit width to permit insertion and removal of the bits through the extraction zone of the slot opening.

8. The multitool of claim 1, wherein each end of the slot has a retention mechanism for axially securing the bit in the storage position.

9. The multitool of claim 8, wherein each retention mechanism comprises a respective magnet to attract the bit to the storage position.

10. The multitool of claim 1, wherein the bit retainer includes a spring-loaded ejector having at least one spring in each slot for urging ejection of each bit from the slot when in the extraction position.

11. The multitool of claim 10, wherein the bit retainer has a respective retention mechanism along each storage position of the slot for axially securing a respective bit in the storage position, the retention mechanism including an upper protrusion surface projecting downwardly from a ceiling of the slot to urge the bit downward against spring force of the spring as the bit is slid along the slot from the extraction position toward the storage position, and a lower ramp surface spaced inward from the upper protrusion surface toward the end of the slot for elevating the bit after clearing the upper protrusion surface to facilitate retention of the bit in the storage position.

12. The multitool of claim 1, wherein the at least one tool projects lengthwise along the tool axis from a head end of the handle when in the deployed position, and is nested in the handle along the tool axis when in the stowed position.

13. The multitool of claim 12, wherein the at least one tool is pivotable between the stowed position and the deployed position.

14. The multitool of claim 13, wherein the at least one tool comprises a knife blade.

15. The multitool of claim 12, wherein the bit socket is at a butt end of the handle axially opposite the head end, and is generally coaxial with the tool axis.

16. The multitool of claim 15, wherein the handle has a length along the tool axis and a generally constant cross-sectional profile along the length, the cross-sectional profile defined by a width across the tool axis and a thickness perpendicular to the width, the thickness being at least three-fifths of the width.

17. The multitool of claim 1, wherein the handle includes a plurality of bit sockets into which each bit is insertable, the plurality of bit sockets including a first bit socket oriented coaxial with the tool axis and a second bit socket oriented perpendicular to the tool axis.

18. The multitool of claim 1, wherein the handle comprises a pair of parallel plates configured to capture the at least one tool therebetween when the tool is in the stowed position, and the one or more storage slots are formed integrally in at least one of the plates.

19. A tool comprising a bit retainer integrated into a portion of the tool for storing a plurality of tool bits, the bit retainer including one or more slots, each slot retaining a respective pair of tool bits at axially opposite ends of the slot, each tool bit selectively slidable along a respective slot from a storage position adjacent a respective end of the slot in which the bit is securely retained in the slot, to an extraction position toward a center of the slot from which the bit is removable from the slot for insertion into a bit socket of the tool for use.

20. A bit retainer for a tool comprising a retainer body having one or more slots, each slot retaining a respective pairs of tool bits at axially opposite ends of the slot, each tool bit selectively slidable along a respective slot from a storage position adjacent a respective end of the slot in which the bit is securely retained in the slot, to an extraction position toward a center of the slot from which the bit is removable from the slot for insertion into a bit socket of the tool for use.
